(19) United States
(12) Patent Application Publication
(10) Pub. No.: US 2024/0202544 A1
(43) Pub. Date: Jun. 20, 2024

(54) METHOD OF FEDERATED ENSEMBLE LEARNING AND APPARATUS THEREOF

(71) Applicant: Research & Business Foundation SUNGKYUNKWAN UNIVERSITY, Suwon-si (KR)

(72) Inventors: Jee-Hyong LEE, Seoul (KR); Yonghoon KANG, Suwon-si (KR)

(73) Assignee: Research & Business Foundation SUNGKYUNKWAN UNIVERSITY, Suwon-si (KR)

(21) Appl. No.: 18/535,239

(22) Filed: Dec. 11, 2023

(30) Foreign Application Priority Data
Dec. 14, 2022 (KR) 10-2022-0174504

(51) Int. Cl. G06N 3/098; G06N 3/045

(52) U.S. Cl. CPC G06N 3/098; G06N 3/045

(57) ABSTRACT

The present disclosure relates to a method and an apparatus for performing federated ensemble learning, and the method of performing federated ensemble learning according to the present disclosure may include receiving a global learning model from a server; generating a local learning model based on the global learning model and a RANK-1 matrix; generating a client learning model by training the local learning model based on local learning data; and transmitting the client learning model to the server.

### CROSS-REFERENCE TO RELATED APPLICATION

This application claims the benefit of Korea Patent Application No. 10-2022-0174504 filed on Dec. 14, 2022, which is incorporated herein by reference for all purposes as if fully set forth herein.

### BACKGROUND

### Field

The present disclosure relates to a method and an apparatus for performing federated ensemble learning, and in particular, to a method and an apparatus for performing federated ensemble learning based on a RANK-1 matrix.

Federated learning is a deep learning developed for the purpose of protecting sensitive information, including personal information. The federated learning is based on the process of creating an overall global model based on local models of each client (referred to as a participant, a client, a party, an edge device, a node, a user, etc. as well) participating in the federated learning network.

More specifically, each client collects data, trains a local model, and uploads information about the trained local model to a server. The server collects information about the local model to update a global model and transmits information about the updated global model to a client. The client updates the local model with the information about the global model received from the server.

However, in the case of the conventional method of performing federated learning, various data can be used as a distributed environment develops, and a data distribution becomes a non-independent identical distribution (Non-IID), so the performance in carrying out the federated ensemble learning is lower than FedAvg. In addition, there is a problem in that the model of the federated ensemble learning has become too large to be used on edge devices, increasing the costs.

### SUMMARY

To address the above-mentioned problems, the present disclosure is aimed at providing a method and an apparatus for performing federated ensemble learning requiring less communication and cost.

A method of performing federated learning with a client according to an embodiment of the present disclosure may include receiving a global learning model from a server; generating a local learning model based on the global learning model and a RANK-1 matrix; generating a client learning model by training the local learning model based on local learning data; and transmitting the client learning model to the server.

A client according to an embodiment of the present disclosure may include at least one transmission/reception apparatus; at least one memory storing at least one command; and at least one processor performing the at least one command, and the at least one command may include receiving a global learning model from a server; generating a local learning model based on the global learning model and a RANK-1 matrix; generating a client learning model by training the local learning model based on local learning data; and transmitting the client learning model to the server.

A method of performing federated learning with a server according to an embodiment of the present disclosure may include generating a first global learning model based on global learning data; transmitting the first global learning model to a plurality of clients; receiving a client learning model from each of the plurality of clients; and generating a second global learning model based on the plurality of client learning models.

A server according to an embodiment of the present disclosure may include at least one transmission/reception apparatus; at least one memory storing at least one command; and at least one processor performing the at least one command, and the at least one command may include generating a first global learning model based on global learning data; transmitting the first global learning model to a plurality of clients; receiving a client learning model from each of the plurality of clients; and generating a second global learning model based on the plurality of client learning models.

According to the present disclosure, it may be possible to provide a method and an apparatus for performing optimized federated ensemble learning even in a Non-IID environment.

According to the present disclosure, it may be possible to effectively reduce the cost included in the method of performing federated ensemble learning.

### BRIEF DESCRIPTION OF THE DRAWINGS

The accompanying drawings, which are included to provide a further understanding of the present disclosure and constitute a part of the detailed description, illustrate the embodiments of the present disclosure and serve to explain technical features of the present disclosure together with the description.

FIG. 1 is a block diagram of a system for federated learning according to an embodiment of the present disclosure.

FIG. 2 is a flowchart of a method of performing federated learning according to an embodiment of the present disclosure.

FIG. 3 is a graph for illustrating the effect of the method of performing federated learning according to an embodiment of the present disclosure.

FIGS. 4 and 5 are tables for illustrating the effect of the method of performing federated learning according to an embodiment of the present disclosure.

FIG. 6 is a block diagram of an apparatus according to an embodiment of the present disclosure.

### DESCRIPTION OF EXEMPLARY EMBODIMENTS

Hereinafter, with reference to the appended drawings, the embodiments disclosed in the present disclosure will be described in detail, but, regardless of a drawing reference number, the same or similar components will have the same reference number without a repetition of the description thereof. The terms “module” and “unit/part” for components used in the following description are used interchangeably only in consideration of convenience of writing the present disclosure, so they themselves do not have distinct meanings or roles. In addition, when it is determined that a detailed description of a related art included in describing an embodiment disclosed in the present disclosure may obscure the gist of the embodiment, the detailed description will not be provided. Furthermore, the appended drawings are only for easy understanding of the embodiments disclosed in the present disclosure, and the technology disclosed in the present disclosure is not limited by the drawings and should be deemed to include all modifications, equivalents, and substitutes included in the technology and the scope of the present disclosure.

Terms including ordinal numbers such as “first,” “second,” etc. may be used to describe various components, but the components are not limited by the terms. The terms are used only for the purpose of distinguishing one component from another.

When a certain component is described to be “electrically connected” or “coupled” to another component, it should be understood that the component may be directly electrically connected or coupled to the other component or another component may exist therebetween. On the other hand, when a certain component is described to be “directly electrically connected” or “directly coupled” to another component, it should be understood that no other component exists therebetween. Expressions in the singular form include the meaning of the plural form unless they clearly mean otherwise in the context.

Expressions such as “comprise” or “have” used in the present disclosure are intended to indicate the presence of features, numbers, steps, operations, components, parts, or combinations thereof described in the present disclosure, and are not intended to preclude the presence or the addition of one or more other features, numbers, steps, operations, components, parts, or combinations thereof.

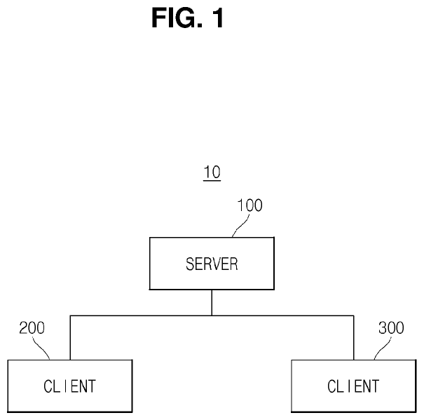

FIG. 1 is a block diagram of a system for federated learning according to an embodiment of the present disclosure.

Referring to FIG. 1, a system 10 for federated learning according to an embodiment of the present disclosure may include a server 100 and a plurality of clients 200. Although only three clients 200 are shown in the drawing, this is merely an example, and the embodiment of the present disclosure is not limited thereto. According to an embodiment of the present disclosure, the system 10 for federated learning may include a VGG-9 based model. Here, the federated learning may be a method of training artificial intelligence models, and may be a method of training artificial intelligence models on the central server by using only the parameters of the artificial intelligence models trained on each local client, rather than by using data on the central server to train the artificial intelligence models.

Based on the distribution of data held by each local client, a data distribution environment may be divided into an independent identically distributed (IID) environment and a not independent and identically distributed (Non-IID) environment. The IID may mean that the distribution of data held by each local client is similar, that is, a similar amount of data and labels are distributed, and the Non-IID may mean that the distribution of data held by each local client is different, that is, different amounts of data and labels are distributed.

The server 100 may include a global learning model and a global learning data. Here, the global learning model may be a learning model created based on the global learning data. The server 100 may transmit the global learning model to each of the plurality of clients 200.

The plurality of clients 200 may each receive a global learning model. Each of the plurality of clients 200 may include a RANK-1 matrix and a local learning data. The plurality of clients 200 may create a local learning model based on a global learning model and a RANK-1 matrix. The plurality of clients 200 may create a local learning model based on Equation 1.

W_{new}=W·(r·s^{T}) [Equation 1]

In Equation 1, W_{new} may be a local learning model, W may be a global learning model, (r·s^{T}) may be a RANK-1 matrix, r may be a first vector, and S^{T} may be a second vector.

The plurality of clients 200 may generate a client learning model by training a local learning model based on local learning data. The plurality of clients 200 may train the local learning model by minimizing the loss function as in Equation 2.

$${L}_{CE} = - log ( \frac{exp ( {x}_{y} )}{{\sum }_{1}^{j} exp ( {x}_{j} )} ) \qquad [ Equation 2 ]$$

In Equation 2, L_{CE} may be the loss function, [symbol] may be a y-th dimension vector, xⱼ may be a j-th dimension vector, and j may be the number of classes.

The plurality of clients 200 may transmit a global learning model and a RANK-1 matrix to the server 100.

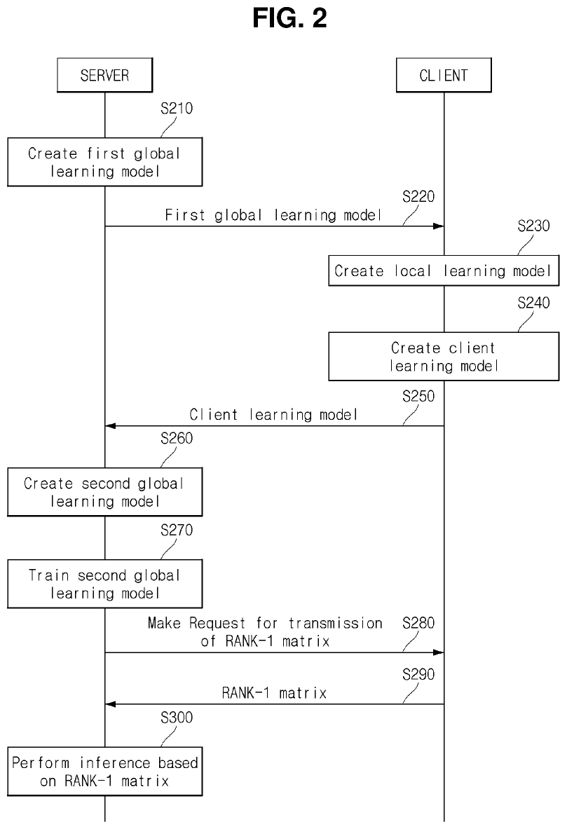

FIG. 2 is a flowchart of a method of performing federated learning according to an embodiment of the present disclosure.

Referring to FIG. 2, a server may create a first global learning model at S210. The server (e.g., the server 100 in FIG. 1) may generate the first global learning model based on global learning data. The server may transmit the first global learning model to each of the plurality of clients at S220.

A plurality of clients may receive the first global learning model from the server at S220. Each of the plurality of clients (e.g., the plurality of clients 200 in FIG. 1) may generate a local learning model based on a global shared model at S230. The plurality of clients may create a local learning model based on a global shared model and a RANK-1 matrix. For example, each of the plurality of clients may create a local learning model based on Equation 1. The plurality of clients may create a client learning model based on a local learning model at S240. The plurality of clients may create a client learning model by training a local learning model based on local learning data. The plurality of clients may transmit a client learning model to the server at S250.

The server may receive client learning models from the plurality of clients at S250. The server may create a second global learning model based on the client learning models at S260. The server may create the second global learning model by calculating the average of the plurality of client learning models. The server may train the second global learning model at S270. For example, the server may train the second global learning model based on global learning data.

The server may request the plurality of clients to transmit a RANK-1 matrix at S280. The plurality of clients may receive the request for the transmission of a RANK-1 matrix from the server at S280. The plurality of clients may transmit a RANK-1 matrix to the server at S290. The server may receive a plurality of RANK-1 matrices from the plurality of clients at S290. The server may perform inference based on the plurality of RANK-1 matrices at S300.

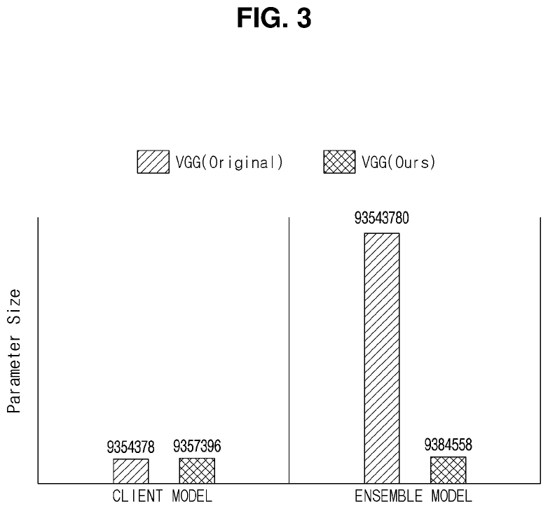

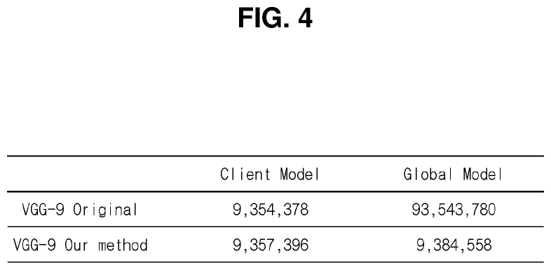

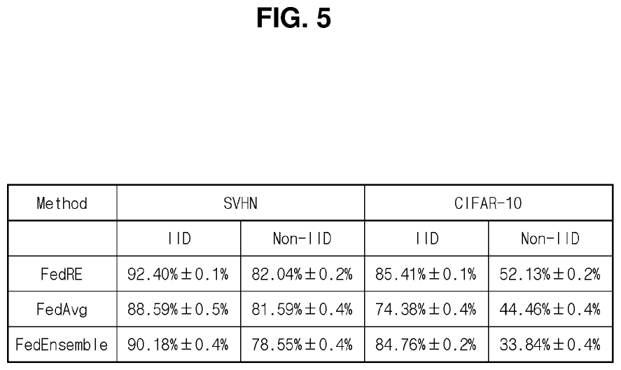

FIG. 3 is a graph for illustrating the effect of the method of performing federated learning according to an embodiment of the present disclosure. FIGS. 4 and 5 are tables for illustrating the effect of the method of performing federated learning according to an embodiment of the present disclosure.

With regard to FIGS. 3 and 4, the CIFAR-10 was used as the experimental dataset, and the VGG-9 neural network was used as the model. 10 clients were used for the learning, 100 rounds were run, and Non-IID was set to Dirichlet α=0.1. Referring to FIGS. 3 and 4, while the global learning model increases significantly in the case of the conventional federated ensemble model using the entire client model, the size of the ensemble model is small in the case of the federated learning model according to an embodiment of the present disclosure where the global learning model includes RANK-1 matrices and a shared model.

Regarding FIG. 5, SVHN and CIFAR were used as experimental datasets, and FIG. 5 shows the result of comparing the performance in image classification when FedRE, FedAvg, and FedEnsemble are used as a method of performing federated learning in IID situations and Non-IID situations. Here, the FedRE may be a method of performing federated learning according to an embodiment of the present disclosure. Referring to FIG. 5, when the method of performing federated learning (FedRE) according to an embodiment of the present disclosure is used, the performance may be improved by about 5% and 50% in the IID situation and in the Non-IID situation, respectively.

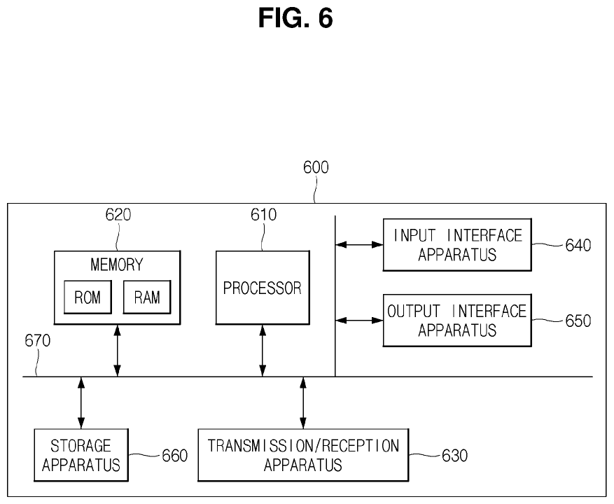

FIG. 6 is a block diagram of an apparatus according to an embodiment of the present disclosure.

The apparatus 600 in FIG. 6 may correspond to the server 100 and the client 200 in FIG. 1. The apparatus 600 may include a transmission/reception apparatus 630 that is connected to at least one processor 610, a memory 620, and a network and performs communication. In addition, the apparatus 600 may further include an input interface apparatus 640, an output interface apparatus 650, a storage apparatus 660, etc. Each component included in the apparatus 600 may be connected by a bus 670 and communicate with each other. However, each component of the apparatus 600 may be connected to the processor 610 by an individual interface or an individual bus, rather than by the common bus 670. For example, the processor 610 may be connected to at least one of the memory 620, the transmission/reception apparatus 630, the input interface apparatus 640, the output interface apparatus 650, and the storage apparatus 660 by a dedicated interface.

The processor 610 may execute a program command stored in at least one of the memory 620 and the storage apparatus 660. The processor 610 may refer to a central processing unit (CPU), a graphics processing unit (GPU), or a dedicated processor by which methods according to the embodiments of the present disclosure are performed. The memory 620 and the storage apparatus 660 may each include at least one of a volatile storage medium and a non-volatile storage medium. For example, the memory 620 may include at least one of a read only memory (ROM) and a random-access memory (RAM).

Most of the terms used in the present disclosure were selected from common terms widely used in the field, but some of the terms were chosen arbitrarily by the applicant and their meanings are detailed in the following description as necessary. Accordingly, the present disclosure should be understood based on the intended meanings of the terms, not the names or the meanings the terms have.

It will be apparent to a person having ordinary skill in the art that the present disclosure can be embodied in other specific forms within the essential features thereof. Therefore, the foregoing detailed description should not be regarded as limiting in all respects but rather as illustrative. The scope of the present disclosure should be determined based on reasonable interpretation of the appended claims, and all changes within the equivalent scope of the present disclosure should be deemed to be in the scope of the present disclosure.

What is claimed is:

1. A method of performing federated learning with a client, comprising:
receiving a global learning model from a server;
generating a local learning model based on the global learning model and a RANK-1 matrix;
generating a client learning model by training the local learning model based on local learning data; and
transmitting the client learning model to the server.

2. The method of claim 1, wherein the generating of the local learning model based on the global learning model and the RANK-1 matrix includes generating the local learning model based on the following equation:
W_{new}=W·(r·s^{T}),
wherein the W_{new} is the local learning model, the W is the global learning model, the (r·s^{T}) is the RANK-1 matrix, the r is a first vector, and the S^{T} is a second vector.

3. The method of claim 1, wherein the generating of the client learning model includes training the local learning model based on the local learning data and the following equation:
$${L}_{CE} = - log ( \frac{exp ( {x}_{y} )}{{\sum }_{1}^{j} exp ( {x}_{j} )} ) ,$$
wherein the L_{CE} is a loss function, the [symbol] is a y-th dimension vector, the xⱼ is a j-th dimension vector, and the j is the number of classes.

4. The method of claim 1, further comprising transmitting the RANK-1 matrix to the server.

5. A client, comprising:
at least one transmission/reception apparatus;
at least one memory storing at least one command; and
at least one processor performing the at least one command,
wherein the at least one command includes:
receiving a global learning model from a server;
generating a local learning model based on the global learning model and a RANK-1 matrix;
generating a client learning model by training the local learning model based on local learning data; and
transmitting the client learning model to the server.

6. The client of claim 5, wherein the generating of the local learning model based on the global learning model and the RANK-1 matrix includes creating the local learning model based on the following equation:
W_{new}=W·(r·s^{T}),
wherein the W_{new} is the local learning model, the W is the global learning model, the (r·s^{T}) is the RANK-1 matrix, the r is a first vector, and the S^{T} is a second vector.

7. The client of claim 5, wherein the generating of the client learning model includes training the local learning model based on the local learning data and the following equation:
$${L}_{CE} = - log ( \frac{exp ( {x}_{y} )}{{\sum }_{1}^{j} exp ( {x}_{j} )} ) ,$$
wherein the L_{CE} is a loss function, the [symbol] is a y-th dimension vector, the xⱼ is a j-th dimension vector, and the j is the number of classes.

8. The client of claim 5, wherein the at least one command further includes transmitting the RANK-1 matrix to the server.

9. A method of performing federated learning with a server, comprising:
generating a first global learning model based on global learning data;
transmitting the first global learning model to a plurality of clients;
receiving a client learning model from each of the plurality of clients; and
generating a second global learning model based on the plurality of client learning models.

10. The method of claim 9, wherein the generating of the second global learning model based on the plurality of client learning models includes calculating the average of the plurality of client learning models to generate the second global learning model.

11. The method of claim 9, further comprising:
receiving RANK-1 matrices from the plurality of clients; and
performing inference on the second global learning model based on the RANK-1 matrix.

12. A server, comprising:
at least one transmission/reception apparatus;
at least one memory storing at least one command; and
at least one processor performing the at least one command,
wherein the at least one command includes:
generating a first global learning model based on global learning data;
transmitting the first global learning model to a plurality of clients;
receiving a client learning model from each of the plurality of clients; and
generating a second global learning model based on the plurality of client learning models.

13. The server of claim 12, wherein the generating of the second global learning model based on the plurality of client learning models includes calculating the average of the plurality of client learning models to generate the second global learning model.

14. The server of claim 12, wherein the at least one command further includes receiving RANK-1 matrices from the plurality of clients and performing inference on the second global learning model based on the RANK-1 matrix.
